(19) United States
(12) Patent Application Publication
(10) Pub. No.: US 2016/0379102 A1
(43) Pub. Date: Dec. 29, 2016

(54) AUTOMATED SYSTEM TO IDENTIFY AND TRACK LUGGAGES USING HF TAGS

(71) Applicant: Ross S FERGUSON, Abu Dhabi (AE)

(72) Inventor: Ross S FERGUSON, Abu Dhabi (AE)

(21) Appl. No.: 15/122,147

(22) PCT Filed: Feb. 25, 2015
(86) PCT No.: PCT/GB2015/050546

§ 371 Date: Aug. 26, 2016

Related U.S. Application Data
(60) Provisional application No. 61/944,924, filed on Feb. 26, 2014.

(51) Int. Cl. G06K 19/07; G06Q 10/08

(52) U.S. Cl. CPC G06K 19/0723; G06Q 10/0833; G06Q 10/087

(57) ABSTRACT

A tag device (800, 900) comprises an RFID tag (101) containing identifying information readable by an RFID reader device (201-209). The tag device further includes a battery and a cellular communications module (808) by which the tag device can communicate with remote systems (210, 212) independently of an RFID reader device. The tag device further includes a satellite position receiver (808). The tag device is operable remotely to report its location via the cellular communication network, in addition to reporting via RFID reader devices.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS REFERENCE TO RELATED APPLICATIONS

This application claims the benefit of U.S. Provisional Application No. 61/944,924 , filed Feb. 26, 2014. The entire contents of the patent application identified above is incorporated by reference herein as if fully set forth.

### TECHNICAL FIELD

Embodiments of the present disclosure relate to apparatus and methods for smart-tags. Embodiments relate to smart-tags. Embodiments relate to methods and apparatus for monitoring and retrieving baggage times using smart-tags. Embodiments relate to apparatus and methods for avoiding accidental collision of a vehicle with a person, animal or other item using smart-tags.

### BACKGROUND

Airlines currently utilize paper bar-coded tags to identify their customer's luggage in transit. The paper tags are not reliable and can be damaged in transit or removed completely, leaving the luggage lost in the system. It is estimated that there are approximately 15 bags lost per thousand passengers and that worldwide there are currently 3.4 billion passengers travelling by air annually. This equates to over 50 million lost bags annually. The maximum available compensation available to the individual is $1,570. This is offset by the airlines auctioning off the lost bags after remaining unclaimed for a period of time.

There is a need to provide improved apparatus and methods for monitoring baggage and other items.

### SUMMARY OF THE INVENTION

In a first aspect, the present disclosure provides a tag device comprising in a self-contained unit:
an RFID tag containing identifying information readable by an RFID reader device;
an electronic communication circuit by which the tag device can communicate with remote systems independently of an RFID reader device; and
a battery for powering said communication circuit.

The electronic communication circuit may include a cellular communications module for communication via a cellular data network.

The tag device may further include a location circuit, for example a satellite position receiver, the tag device being operable remotely to report its location via the cellular communication network. The reporting may be triggered by a remote command, or may be triggered by an event within the tag device.

The tag device may further be operable to obtain and report a location based on trilateration using a cellular network.

The tag device may further include an RFID reader interface for transferring information from the RFID tag to the electronic communication circuit.

The tag device may further include an RFID write interface for transferring information to the RFID tag from the electronic communication circuit.

The tag device may further include an RFID tag power interface for intermittently powering the RFID tag from the battery.

The tag device may include a power management function for automatically disabling components of the tag device to maximize battery life.

The power management function may include one or more of an accelerometer and an altitude meter. The power management function may operate by comparing sensed locations over time.

The above and other functions of the tag device can be controlled by a microcontroller within the device.

The tag device may include at least one of a satellite GPS device, a Bluetooth communication device, a near field communication device and a WiFi communication device.

In another aspect, the present disclosure provides a computer-implemented method for monitoring and retrieving items such as baggage, the method comprising:
receiving user information in a computer processing system;
based on said received user information, programming, by said computer processing system, at least one RFID tag for tagging at least one baggage item;
receiving, by said computer processing system, a user interface entered selection of at least one identifier of the at least one RFID tag associated with the at least one baggage item;
electronically tracking said selected at least one RFID tag;
determining, by said computer processing system, the geographic location of said selected at least one RFID tag and/or status information about said RFID tag according to said electronic tracking; and
presenting on the user interface the geographic location and/or the status information on the user interface for monitoring said at least one tagged baggage item.

The programming, by said computer processing system, at least one RFID tag based on said user information may for example comprise programming a plurality of RFID tags for tagging a plurality of baggage items; and receiving, by said computer processing system, a user interface entered selection of the at least one RFID tag identifier may comprise receiving, by said computer processing system, a user interface entered selection of the at least one RFID tag identifier selected from among RFID identifiers of the plurality of said RFID tags.

The programming, by said computer processing system, at least one RFID tag based on said user information may comprise programming a plurality of RFID tags for tagging a plurality of baggage items. The receiving, by said computer processing system, a user interface entered selection of at least one RFID tag identifier may comprise receiving, by said computer processing system, a user interface entered selection of a plurality of RFID identifiers selected from among RFID identifiers of the plurality of said RFID tags; and

wherein electronically tracking the at least one RFID tag comprises electronically tracking concurrently said selected plurality of RFID tags.

There is also disclosed an apparatus for monitoring and retrieving baggage items, the apparatus comprising:
a memory storing instructions; and
one or more processors, wherein said instructions, when processed by the one or more processors, cause:
receiving user information in the apparatus;
based on said received user information, programming, by said computer processing system, at least one RFID tag for tagging at least one baggage item;
receiving, by said computer processing system, a user interface entered selection of at least one identifier of the at least one RFID tag associated with the at least one tagged baggage item;
electronically tracking said selected at least one RFID tag;
determining, by said computer processing system, the geographic location of said selected at least one RFID tag and/or status information about said RFID tag according to said electronic tracking; and
presenting on the user interface the geographic location and/or the status information on the user interface for monitoring said at least one tagged baggage item.

The instructions, when processed by the one or more processors, may further cause intelligent switching between at least two of RFID, GPS, Cellular, NFC, Bluetooth and Wifi technologies to determine the location of the tag device.

The apparatus, or at least part of the apparatus that provides the user interface, may be implemented by programming a user device such as a smartphone or tablet computer.

There is also disclosed a non-transitory computer-readable storage medium including instructions which, when processed by one or more processors, cause an RFID tag computing system to provide a method for monitoring and retrieving baggage items, the method comprising:
receiving user information in the apparatus;
based on said received user information, programming, by said computer processing system, at least one RFID tag for tagging at least one baggage item;
receiving, by said computer processing system, a user interface entered selection of at least one identifier of the at least one RFID tag associated with the at least one tagged baggage item;
electronically tracking said selected at least one RFID tag;
determining, by said computer processing system, the geographic location of said selected at least one RFID tag and/or status information about said RFID tag according to said electronic tracking; and
presenting on the user interface the geographic location and/or the status information on the user interface for monitoring said at least one tagged baggage item.

There is also disclosed a computer-implemented method for preventing accidental collision between a vehicle and a person, animal and/or item, the method comprising,
electronically detecting at least one RFID tag carried on a person, animal and/or item in the vicinity of the vehicle; and
determining, by a computer processing system, the proximity of said at least one RFID tag to the vehicle according to said electronic detecting; and
controlling the motion of the vehicle according to the determined proximity of said least one RFID tag to the vehicle.

These and other aspects and advantages of the disclosure will be appreciated by the skilled reader from a consideration of the examples that follow.

### BRIEF DESCRIPTION OF THE DRAWINGS

Embodiments of the invention will now be described, by way of example only, with reference to the accompanying drawings in which:

FIG. 1 is a schematic diagram depicting components of a remotely operable tagging device according to one embodiment;

FIG. 2 is a schematic system diagram indicating various components of a tagging and tracking system according to one embodiment;

FIGS. 3 and 4 are schematic diagrams showing exemplary general computer hardware components of a smart-tag server and user device, respectively, according to one embodiment;

FIG. 5 is a schematic hardware diagram of a user device in the form of a mobile phone;

FIG. 6 is a schematic diagram illustrating exemplary software modules for implementing the smart-tag system according to one embodiment;

FIG. 7 is a flow chart outlining a method for performing monitoring and retrieval of baggage items according to one embodiment;

FIG. 8 is a schematic block diagram of hardware of a tag device according to one embodiment;

FIG. 9 is a schematic block diagram of hardware of a tag device according to another embodiment;

FIG. 10 is a block diagram of firmware programmed within the tag device of FIGS. 8 and 9;

FIG. 11 is a block diagram of software implementing a tracking application in a user device; and

FIG. 12 is a diagram of overall data flow in the system of tagging devices, server and user devices.

### DETAILED DESCRIPTION OF EXEMPLARY EMBODIMENTS

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

References to specific components, process steps, and other elements are not intended to be limiting. It will be further noted that the figures are schematic and provided for guidance to the skilled reader and are not necessarily drawn to scale. Rather, the various drawing scales, aspect ratios, and numbers of components shown in the figures may be purposely distorted to make certain features or relationships easier to understand.

The term “user” as used herein refers to an individual that uses a personal computer (PC), mobile device, or other electronic user device to access and use, across an electronic network, the services provided by the tagging and tracking system. A registered user is a user that has registered with the smart-tag system such that he/she is allowed to perform tag device management and tracking.

The device or Smart-Tag is a personalized tag that incorporates Radio Frequency Identification (RFID) technology, which is designed for easy identification by the owner of the tagged item and the protection of personal items—e.g. checked baggage, whilst in the possession of airlines, airports or other travel mediums by land or sea—e.g. trains, buses, ships etc. and their Operators.

In a particular embodiment of the present disclosure, an electronic circuit contained within the smart-tag device provides the platform for powered circuits for global positioning by satellite (e.g. GPS) and mobile network cellular-ID (e.g. GSM) for communicating with and locating the device. The RFID component may be a passive component of the device design, which does not require any power. Different standards and implementations of RFID tag are known, and the present disclosure is not limited to any particular type. Alternatively it will be a powered or active RFID tag, powered intermittently under control of other components. The internal battery within the electronic circuit will have a battery life of 1 to 2 weeks and will be rechargeable by the owner. The device will incorporate an accelerometer, which will allow the device to hibernate and save power when not in motion. The device will also have an outlet socket to connect with a USB lead for hard wire communication to give battery-charging options for smart phones, tablets, laptops and other hardware.

As mentioned in the introduction, one application area for the smart-tag device and system is for tracking and tracing baggage in the air travel environment. Currently airlines use bar-coded paper tags to identify their customers' baggage in transit. In one approach, the information stored on the RFID tag device belongs to the individual. Referring to an airline and baggage tracking application, by way of example only. the information can be read by tag device readers at airline check-in desks and at various strategic points in the system, depending on the travel medium. For example for airlines and airports the information can be read at points between the check-in desk and stowing the baggage in the aircraft hold on departure, and between unloading the aircraft and receiving the baggage from the baggage re-claim belt on arrival. Visual displays and audio announcing of bags fitted with a tag device is possible as the bags enter the re-claim belt. This is achieved using RFID readers coupled to processors with software written to link up with audio/visual equipment. The software used by the airports and the airlines will make real time inventory management data available and ensure that flight delays are minimized due to baggage problems.

In one example, the airport and airline workers can also utilize hand-held RFID readers to quickly identify baggage at any given time. The tag device will also aid airport security as security officers can also use hand-held readers to identify the owners of unattended baggage.

In one embodiment, the tag device is a credit card size RFID tag encased in a robust outer shell, which is anchored temporarily or permanently to the baggage. However, the technology is not limited in size and in other embodiments, large or jumbo tags can also be produced to increase visibility for oversize baggage similarly half, quarter and eighth size tags can be developed for child, pet and other applications, where size reduction is appropriate.

In one example, the RFID tag is laminated between dual facing personalized displays that can be customized to suit an individual's or company's needs—i.e. colors, designs, alpha numeric characters, type-script, patterns, shapes, logos, photographs, iconic people, clan crests, country flags—the options are unlimited. The tag device can have the same design on both sides or two differing designs to suit the needs of the owner. The tag device housing is designed to be virtually indestructible and guaranteed for life unless it is deliberately destroyed. The purpose of the robust outer shell is to provide a durable product that will stand the test of time and the excesses of the journey from check-in to pick-up from the baggage re-claim belt.

In some embodiments of the tag device, the personal data belongs to the tag device owner and is first encoded onto the tag device at manufacture. The information is held in a tag device database and can be accessed and/or updated by the tag device owner via the internet using their unique ID or personal identity number (PIN). The same PIN can be used at the airline check-in desk to give permission for the airline to write data to the tag device for the journey—e.g. flight number(s) and destination code(s) using RFID reader/writers coupled to processors with software written to utilize the travel itinerary data.

In one approach, retail kiosks are disposed in airports, train stations, bus and sea-port terminals, thereby allowing customers to buy new tag devices or to write data to existing tag devices prior to checking in with read/write equipment at the kiosks. In some examples, mobile phones, such as but not limited to fourth or fifth generation mobile phones (smartphones), support applications and have the capability to read/write to RFID tag devices using chip & PIN software, either embedded in the device or through an interface plug in reader. In some embodiments, the reader could also be plugged into the USB port of a personal Laptop, Notebook or Tablet PC. In theory bags fitted with tag devices should never be lost in transit as airlines, airports and the other travel forms/Operators will have the necessary RFID scanners to read the tags and locate bags at any point in their systems—i.e. for airlines and airports between check-in and delivery onto the baggage re-claim belt.

In some embodiments, the tag device uses international standard RFID protocols for worldwide compatibility and usage. Tag devices could also be incorporated into luxury branded products such as Samsonite®, Louis Vuitton®, Gucci®, Antler®, Delsey®, Prada®, luggage etc.

Compared with existing arrangements, a difference with the tag device in one approach is that the investment in the RFID technology is by the customer and the RFID tag is encased in a much more durable, robust shell than the paper tags used by the airlines. The customer in effect allows the airline to utilize their personal data portal during the time their baggage is entrusted to the airline, in much the same way that they entrust the airline with the baggage itself. The data held on the tag device is protected against unauthorized writing by chip and PIN protocols, but key data fields can be read by a number of devices equipped with the correct processors and software. The highly personalized individual designs and styles combined with their personal baggage, size, color and type, make them unique to the customer and more easily identifiable on the baggage re-claim belt.

In one approach, the use of tag device automates the check-in process and reduces the reliance on high numbers of staff at the check-in desks, where a combined RFID Read/Write interface and weigh scale/Printer is used by fast-track passengers to weigh their baggage, print the airline baggage tag and put direct onto the baggage conveyor. Currently only on-line check-in and bag drop is offered by the airlines but this still requires an interface at the bag drop counter. Using the disclosed tag devices will automate this process. The use of the disclosed tag devices with hand luggage will allow security personnel and scanner Operators to ensure that the hand baggage actually belongs to the individual, who is presenting their passport for inspection, thereby preventing theft of the baggage or identifying unattended baggage more easily.

Currently there are 1,541 passenger airports operating in 177 countries across the world, with the top 30 international hubs accounting for almost 40% of the 3.4 Billion passengers carried by the airlines annually. Each passenger is generally allowed two checked bags on average.

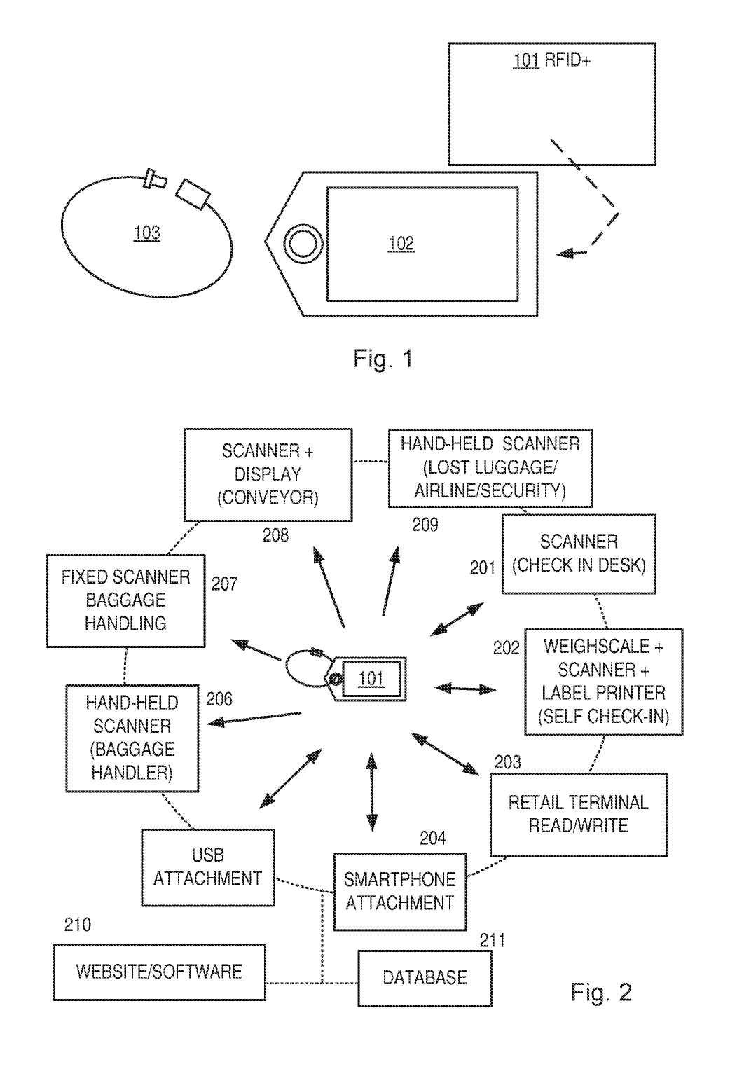

FIGS. 1 and 2 give an impression of the overall tagging system, which can be developed in connection with a technology partnering agreement for a smart-tag provider and the equipment provided in an exclusive supply agreement based on a cost plus model for the manufacturer. Smart-tag kiosks lend themselves well to a franchise business proposition with minimum start-up costs for the franchisee.

Non-limiting examples of the aforementioned approaches and embodiments will be described in more detail below. Reference will now be made to the accompanying drawings in which the various elements of embodiments will be given numerical designations and in which embodiments will be discussed so as to enable one skilled in the art to make and use the embodiments.

FIG. 1 is a schematic diagram depicting components of a tag device, associated tag holder device 102 and attachment wire 103 according to one embodiment. In one example, the tag device includes an RFID chip carried on a tag 101. In addition to an RFID chip, the tag device carries cellular communication device (for example GSM) and a satellite positioning device (e.g. GPS). The function of these devices will be described further below. The RFID tag has a unique design personalized to the owner. The design is color printed onto both sides of the base RFI tag, normally credit card size but with other sizes available.

The tag holder device 102 has a protective casing having an attachment point. In one example, the casing is an outer protective case for the tag device which is an injection molded tag holder and which is re-enforced at the attachment point with a metal ferrule. The RFID tag 101 is sized and configured to slide into the protective case 102 and snap permanently into the aperture. Once fitted, the RFID tag 1 cannot be removed from the protective case. The tag holder, and tag device carried therein, is then attachable to the baggage. In one embodiment, the holder is attachable by a securing ring, such as a stainless steel wire with a screw fitting sized to pass through the metal ferrule.

Reference will now be made in more detail to an exemplary tagging system according to one embodiment. As depicted in the schematic system diagram shown in FIG. 2, the tagging system may have any or all of the following Hardware/Software components, devices or apparatuses, which are operable in communication with the RFID tag 101.

Item 201 is a check-in desk scanner with read/write access. The scanner 201 at the check-in desk will communicate with the tag device. The owner will key in their PIN allowing the operator to write airline journey data to the tag and baggage weight. Identifying heavy baggage will prevent injury to airport workers and help to eliminate manual handling injuries. Software required for the hardware to function as desired can be provided and licensed to airlines and airport operators etc. for inclusion in their own check-in hardware, if desired.

Item 202 is a self-check-in combined weigh scale/printer and tag device reader. This equipment at a self-service check-in desk will communicate with the tag device. The owner will key in their PIN allowing the airline journey data to be downloaded to the tag and baggage weight confirmed in the airline manifest. This self-service check-in desk can also be combined with a passport scanner and printer to facilitate printing of boarding passes as well as airline paper baggage labels. Software required for the hardware to function as desired can be licensed to airlines and airport operators etc. for inclusion in their own hardware, if desired. In one approach, the check-in process is fully automated and improved over on-line Item 203 represents a franchise kiosk terminal with read/write access to the smart-tag. In one approach, a franchise kiosk is provided at the airport or other location to allow users (e.g. passengers) to buy tag devices. The user then can enter their basic data into a website server 210, through which it will be transferred onto the newly purchased tag device. The owner keys in their PIN allowing them to write their basic data to the tag and to the website server, prior to proceeding to check-in either assisted by an Operator at the check-in desk 201 above or at the self-check-in facility 202. Software required for the hardware to function as desired may be built in to kiosk hardware, and/or licensed to franchisees to use with their own hardware.

Item 204 is a smart phone interface attachment and application for tag device read/write access. In this embodiment the RFID read/write technology is embedded into a portable communication and/or computing device such as a smartphone or tablet. Alternatively the same effect can be achieved using an interface attachment for a pre-existing phone. The owner attaches the interface to the tag device and their smartphone, opens up an application on the phone and keys in their PIN. This allows them to read from or write to the tag and to the website server. This data read or written can be for example basic data or details of their next travel itinerary prior to heading to the airport. Software required for the hardware to function as desired can be provided and licensed under the purchase agreement for the Smart-phone App.

Item 205 represents an attachment for use with a laptop, notebook, tablet PC and associated software for tag device read/write access. The attachment may be for example connected to the computer via a USB interface. In one embodiment, an interface attachment allows owners of laptops, desktop PC's, notebooks and tablet PCs RFID read/write access to their tag devices. The owner connects the interface to the tag device and their device, which opens up the software on their desktop, and key in their PIN allowing them to read from or write to the tag, and read from and write to the website server via the internet. This can be basic data or details of their next travel itinerary prior to heading to the airport. Software required for the computer hardware to function as desired can be downloaded from the tagging system website licensed under a software agreement.

Item 206 represents a hand-held scanner with tag device read only access In one embodiment, the device is designed to allow baggage handlers to quickly identify the owner and the flight itinerary for any given item of baggage at any point in the system. Software required for the scanner hardware to function as desired can be licensed to airlines and airport operators etc. to use with their own scanning hardware, if desired.

Item 207 represents a fixed scanner with tag device read only access. This device is designed to be fixed at strategic points in the baggage handling system to track any given item of baggage between check-in and stowage in the hold of the aircraft or from the aircraft hold to delivery on the baggage re-claim belt. Software required for the scanner hardware to function as desired can be licensed to airlines and airport operators etc. to use with their own scanning hardware, if desired.

Item 208 is a digital display and audio annunciation unit. This unit is designed to work in conjunction with item 207 above in two ways. Firstly, when baggage is coming onto a large baggage re-claim belt, and at strategic points along the belt, a passenger's tag can be read and scrolling digital display of the passenger's name given along with audio annunciation through a speaker system. The second application allows heavy baggage to be routed separately through the baggage handling system. In this way, sufficient numbers of Operators can be deployed to lift heavy baggage, thereby helping to eliminate manual handling injuries and lawsuits from Operators with injuries. Software required for the scanner hardware to function as desired can be licensed to airlines and airport operators etc. to use with their own scanning hardware, if desired.

Item 209 is a lost luggage hand-held scanner with tag device read only access. This item is a derivative of the hand-held scanner item 206 above, developed to deal with lost or unidentified items of baggage. It can also be used by security personnel to prevent potential threats from unidentified or unattended baggage. It can also be used to prevent theft when the tag device information does not correlate with the passenger's information when they present their identification—e.g. passport. This device has greater access to the data held on the tag device for security purposes. Software required for the scanner hardware to function as desired can be licensed to airlines and airport operators etc. to use with their own scanning hardware, if desired.

Item 210 is a tag device administration website and software, with associated database 211. These elements 201-211 communicate via a local area network and/or the internet to share location information about the scanned tags. In this way a variety of functions can be implemented as explained below. In addition, as previously mentioned, RFID tag 101 is combined in a self-contained tag device with an electronic communication circuit, for example GSM cellular phone module, and a battery. Using these components, the tag device can communicate with a cellular communication network 212. Thus even when it is not in proximity with an RFID receiver, the tag device can communicate with website and software 210 in ways to be described further below. Additionally, in an embodiment, the tag device can include a location circuit such as a GPS receiver, for receiving position information from a satellite network 213 or other source. In one approach, the tag device provider has a dedicated website and dedicated servers to hold a master database of Smart-Tag information. This system (described and illustrated further below) allows users to regularly update the information held on their tag device or to update the base data or write repeat data to multiple tag devices they own for all checked luggage and hand luggage.

It is envisaged that one family could have a number of tag devices. Software will provide for the smooth and seamless operation of the interface units required for communication between the website servers and the devices above.

In one aspect, a relevant application for any of the family of tags is E-Alert. This may be implemented for example in embodiments where the tag device has a GSM or other cellular communication function built in. In the same way that smart phones can seek out a Wi-Fi access point, then the Smart-Tag can seek out a cellphone network via the nearest cellphone repeater to send a location signal. This procedure can be activated for example in the event that the tag owner initiates the E-Alert to flag up that the tagged item is missing—i.e. no longer in their possession and that they really badly want to get it back by the fastest possible means. Once the E-Alert is triggered the tag device software calculates the retrieval options including but not limited to advising emergency services, notifying airlines or other third parties. A useful feature may be the ability to provide the user with a powerful search engine that can facilitate all necessary data retrieval for contact numbers (airlines etc.), calculation of timescales, route, etc. for retrieval.

Additionally, the tagging system for baggage system can be augmented by tags adapted for tracking precious pets and/or children. The system can be adapted also for access control applications. Interfacing with cellphone networks provides a revenue stream for the network provider as when the App is operational the data streaming or air time taken up has to be paid for by the user in much the same way as they currently pay for a cell phone call. The revenue stream can be shared between the network provider and the tag device provider.

The system software works using the GPS and cellular hardware that sits (in the tag device and in the surrounding infrastructure) alongside the RFID hardware. Dedicated software applications will pinpoint the exact location of the tagged item wirelessly. It will works by scanning different frequencies and connection types for example GSM, Bluetooth, GPS and more finding the best one for working out the exact location of the tagged items.

More detail of the implementation of the software will be provided below. The main features of the software are:
The ability to add more than one tag device at the same time
Personal Environment
Multi-platform support
Custom plug-in system for personal Expansion of software
Localized theme system

These will now be described in turn.

The Ability to add more than one tag device: The software supports an unlimited number of tag devices. The system allows each tag to have its own ID within the software. At a main screen the user is shown the tags registered with the user device. The user is then prompted to select the tag device details the user wishes to view and the device they wish to find the location of.

Personal Environment: Referring for example to an Android® software environment, we note Android's ability to support multiple languages. In one approach, the software program is developed in the programming language C# and ported to Java® with added support for Theme classes. Users and developers can thus develop custom environments. In one example, an environment designer is included in the program itself

Multi-Platform: In one example, using development tools that are on the market, the program's base is in one language and then ported to the desired platform. If required any extra features for that platform are included.

Custom Plug-In System: In one approach, for an Android® system support for plug-ins is included in the program, much like browsers support plug-ins. Developers are then able to add upgrades to the tag device administration system.

Localized Theme System: Because of the way the system is utilized, logos and content are adopted, which are customizable. This means that at check in, airports can add customized themes to the tag device and in turn the Applications. This way the Airlines can advertise their logo on the Application and even update the software to show departure times and other information based on the airport specific location.

According to another aspect, a key functionality of the tagging system is the ability to interface with other systems. With car satellite navigation systems for example it can detect proximity of children or pets stepping off the sidewalk between parked cars and presenting a hazard to drivers. The close proximity of the tag device linked to automated smart car systems allows car manufacturers to sense the imminent danger and brake the car to prevent a fatal accident. The width of the road can be effectively broken down into zones—i.e. the amber warning zone and the red danger zone, when a child or pet steps off the sidewalk between two parked cars—the amber warning zone to where they are in danger of being struck by a moving vehicle—the red danger zone.

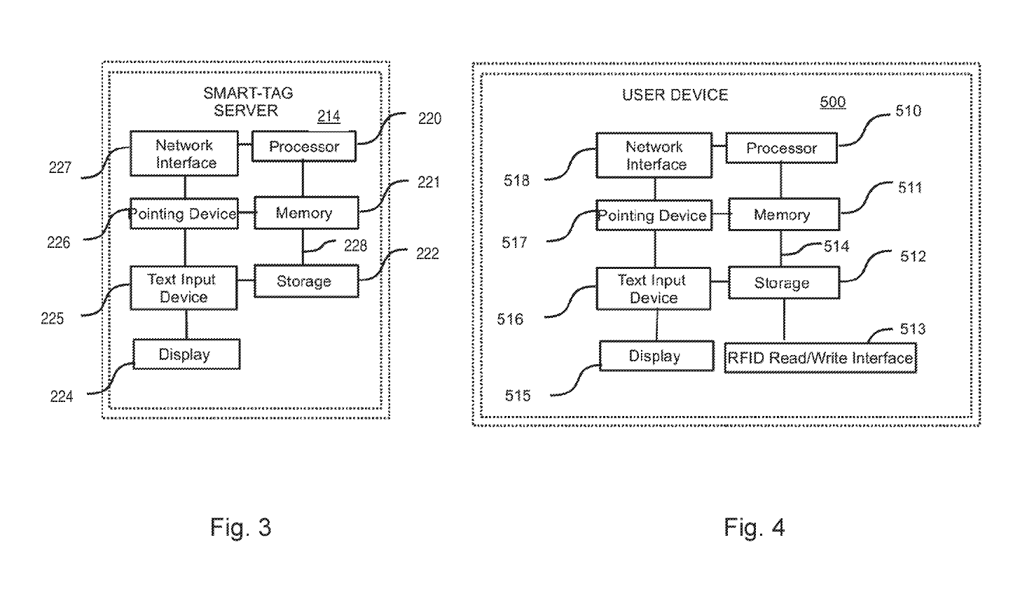

Reference will now be made to exemplary embodiments of computer hardware and software configurations for the aforementioned tag devices and associated administrative computer systems. In one embodiment, the administrative computer system includes a server referred to as the “smart tag server”. This server may be implemented using a general hardware configuration for example, as shown in, but not limited to, FIG. 3.

There may one server or a plurality of interconnectable servers which may be physically located locally and/or remotely from for example the airport locations. Smart tag server 214 has a central processor unit (CPU) or other processor 220, operable to execute one or more programs, including the smart-tag application module under the control of program software provided in memory 221, such as random access memory (RAM), and also in a storage memory 222, such as a disc drive. The storage memory 221 and the memory 222 are also available to the processor unit 220 as temporary or permanent storage of results and data. A network interface 227 is coupled to the processor unit 220 and permits communication between the processor unit 220 and local and/or external network devices over a network. One or more data buses interconnect the smart-tag server 214 components shown in FIG. 3.

Processor unit 220 is coupled to receive input from one or more input devices that may be, but not limited to, a pointing device 226, such as a mouse, pad or touch screen and a text input device 224, such as a keyboard or touch screen. Other input devices capable of receiving human-entered input selections for locally setting up and operating the smart-tag system can be adopted, in addition or in place of devices 225 and 226. The processor unit 220 also drives a display 224 that displays images and provides sounds, as controlled and provided by the processor unit 220. Alternatively, one or more of the input devices 225-226 may be omitted and the server can be set up via remotely-connected devices.

The overall system includes not only the tag devices and the smart tag server, but also user devices. User devices referred to herein are data processing units, such as mobile phones, smart phones, computer notebooks, tablet devices and airport kiosk processing units, or other types of computerized devices capable of performing the functionality of the user devices as referred to in the embodiments described herein. Each user device may be the same or different from another user device.

The computerized user devices having a general hardware configuration for example, shown in, but not limited to, FIG. 4. Each user device 500 has a processor unit 510, memory 511, storage 512, display 515, network interface 518 and input devices. Input devices may be a pointing device 517, which may be for example a mouse, pad or touch screen, and a text input device 214, such as a keyboard or touch screen. In one example, the user device includes RFID read/write hardware and interface 513 for enabling reading and writing of the RFID tags of a user's tag devices. These components are interconnected via data bus connections 514. The processor unit 510 may be a Central processor unit (CPU) or other processor circuitry operable to execute one or more programs, including a client-user application module under the control of program software provided in memory 511, such as random access memory (RAM), or in a storage memory 512, such as a disc drive. The storage memory 512 and the memory 511 are also available to the processor unit 510 as temporary or permanent storage of results and data. Network interface 518 is coupled to the processor unit 510 and permits communication between the processor unit 510 and the smart-tag server 200 and with any other user devices over network.

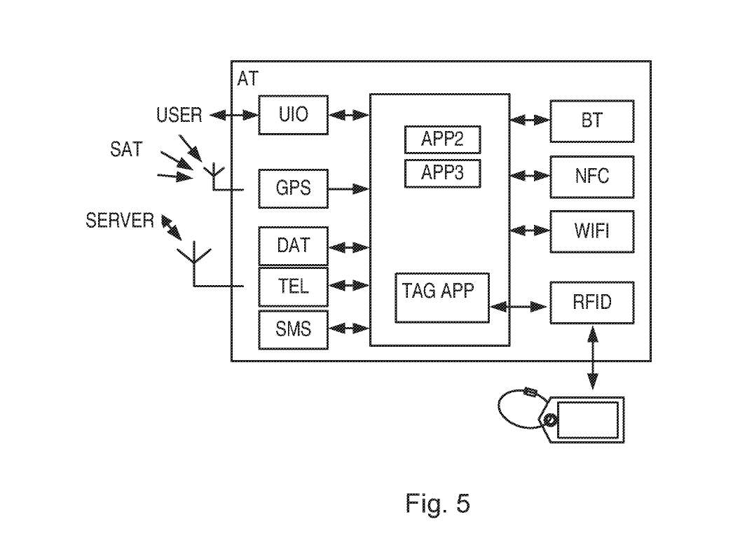

FIG. 5 is a schematic block diagram of a user device having the form of a mobile phone, such as a modern smartphone. In the example illustrated, the user device has the functionality of the user device of FIG. 4, but with the additional components of is a mobile phone handset with or tablet with cellular data and GPS capability. Other types of hardware can be used to implement fixed and/or mobile user devices. In terms of computer hardware, typical elements of a smartphone are provided, namely user I/O systems UIO, cellular network interfaces for data (DAT), voice (TEL) and SMS text messaging (SMS). Processors and memory (RAM, ROM etc.) are provided but not illustrated separately. Suitable operating systems (for example Android®, BlackBerry OS®, iOS® or Windows Phone®) are implemented in firmware and software so that various applications can run on the hardware. A GPS receiver is provided for receiving satellite signals and providing geolocation data to applications. Also provided are local network interfaces such as Bluetooth® (BT), near field communication (NFC) and Wi-Fi.

The user device in this example also is provided with an RFID interface for reading and writing data to an RFID tag, such as the one in tag device 101. The RFID interface can be integrated in a smartphone, or provided as an attachment to communicate with the smartphone by a wired or wireless connection.

The applications running in this case include a smart tag management application TAG APP, while other applications APP1, APP2 etc. can be installed in parallel. The smart tag application communicates with a user via user I/O systems UIO, displaying information and dialog screens such as those illustrated and described already. The application communicates also with server 214 (FIG. 3) via the cellular network data interface DAT. In other words, the generic network interface 518 of the generic user device 500 (FIG. 4) can be implemented by the cellular network interface DAT in a smartphone implementation of the user device.

Application smart-tag modules can include instructions for performing computer implemented operations described herein. One example of the computer software for the smart-tag system will now described for the purpose of operating the smart-tag system for monitoring and retrieving baggage items.

In FIG. 5 an exemplary computer software configuration according to one embodiment is depicted in block diagram form. Software system 400 has smart-tag application modules which are stored in system storage/memory of relevant computer systems and devices. Each software system can include a kernel or operating system and a shell or interface. One or more application programs or modules, such as the smart tag application module, may be “loaded” (i.e. transferred from storage into memory for execution by the processor). The system receives user commands and data through user interface; these inputs may then be acted upon by the smart-tag server, in accordance with instructions from an operating module and/or application module.

Note that the term “module” as used herein may refer to a collection of routines and data structures that perform a particular task or implements a particular abstract data type. Modules may be composed of two parts: 1) an interface that lists the constants, data types, variable, and routines that can be accessed by other modules or routines and 2) an implementation that is typically private, accessible only to that module, and includes source code that actually implements the routines in the module. The term “module” may also simply refer to an application, such as a computer program design, to assist in the performance of a specific task.

In the non-limiting example shown in FIG. 5, a smart-tag applications server comprises a software system 440 that can include a user interface 401, tag device programmer module 402, tag logo and content customizer module 403, lost baggage item E-alert manager 405, locate tracking module 406, global tracking module 407 and return found baggage manager 411.

The software system can include databases, libraries, and other indexes or searchable data storage systems for storing data, including, for example, user profile data, administration data and authentication data. Such databases and other storage systems can be stored in storage/memory which can be located locally or remotely from the processor. In the example of FIG. 5, the software system 440 also includes user databases, libraries and/or other storage systems that store data associated with the system. In particular, the software system has a tag database 410, airport tracking database 409 and global database 410. Any one or all of the aforementioned databases may be located locally, or remotely and accessible over the internet or cloud network.

Software system 400 also includes a user device software system 450 which is loadable or pre-loaded on the user device (FIG. 4/5) and has a user application module 451 and browser 452 module that enables the server to provide smart-tag monitoring and retrieval on the user devices. In one non-limiting example, the smart-tag user interface is implemented as an interactive Web page that is provided by the smart-tag application server to the user device for display through a web browser. Also as shown in FIG. 5, the user application includes optionally a RFID read/writer module.

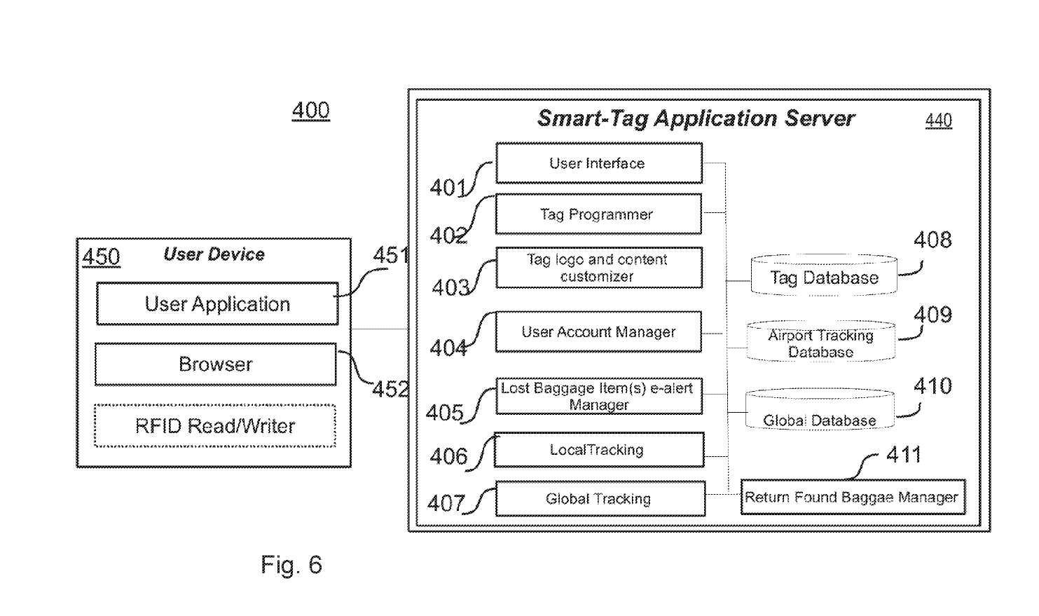

The software system described and shown in FIG. 6 is just one example of the software configuration for performing the smart-tag process of the described embodiments. Other software configurations are envisaged for performing the same functionality and/or other functionality of the described embodiments—with or without all modules—that are capable of providing the smart-tag functionality of the embodiments.

In various embodiments, the software system can be implemented as a client or as a server, or both as client and server. In other embodiments, other architecture is envisaged for implementing the smart tag software, such as peer-to-peer architecture.

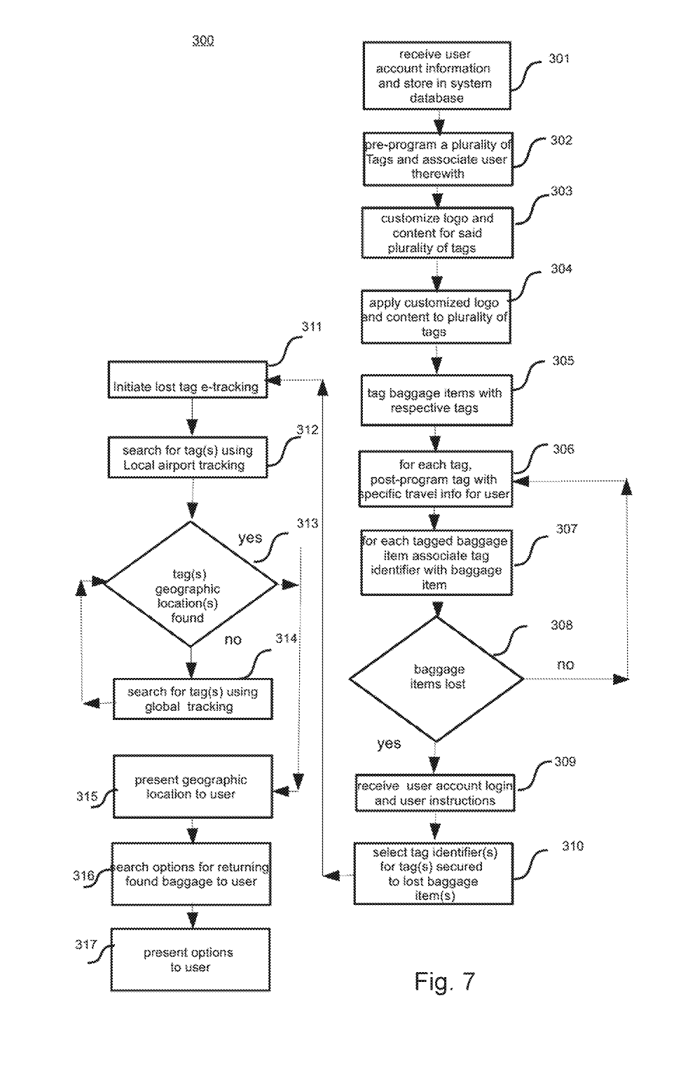

Methods of monitoring and retrieving baggage items will now by described according to one embodiment with reference to the flow chart of FIG. 7. The method 300 can be implemented by for example using the exemplary hardware and software described hereinbefore. Initially, the smart-tag server 214 receives user account information and stores this in a database (step 301). A plurality of smart-tag devices (referred to now as “tags” for brevity) are pre-programmed and the system associates the plurality of tags with a specific user (302). The logo and content of the plurality of tags is then customized by the system (303) and applied to the tags using printing and other manufacturing methods (304). The user is provided with the programmed and customized plurality of tags and the user tags baggage items with respective tags (305). For each tag, the user can post-program one or more tags with travel and/or other info specific to the travel itinerary of the user (306). Each RFID tag applied to a baggage item has an identifier that is associated in the system with the respective tagged baggage item (307). In the event that a baggage item is lost whilst the user is in transit (308), the user can login to the smart-tag system and enter instructions (309). The particular tag identifiers associated with the RFID tags carried by the lost baggage items can be selected by the user (310). In response, the system initiates a lost tag e-tracking process (311) and searches for the lost RFID tags using local airport tracking and/or global tracking. Initially, the system determines the location of the user device and starts the search using the local tracking in the vicinity of the user. If the lost tag's geographic location is not found (313), the system proceeds to search tags using global tracking (314).

Examples of local tracking processes are 1) reaching out to server on airport that is tracking local tracking within airport using RFID, 2) near field communication using mobile device itself, and 3) Bluetooth.

Once the location of the lost tags is found either by local or global tracking (313), the system presents the geographic location of the lost tag or each lost tag on the user device of the user (315). The system then searches and mines for different options for returning the baggage item to the user location or preferred location selected by the user (316). The system then presents those options on the user device (317). It will be understood that other embodiments are not limited to the particular sequence of processes shown in FIG. 7 and/or that some processes of method 300 may be omitted.

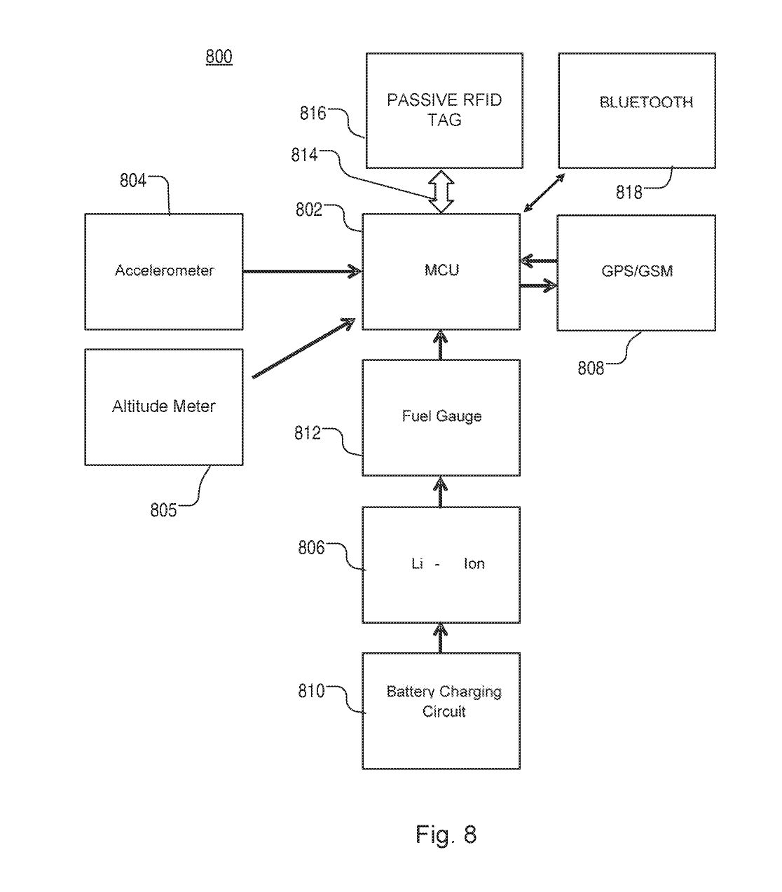

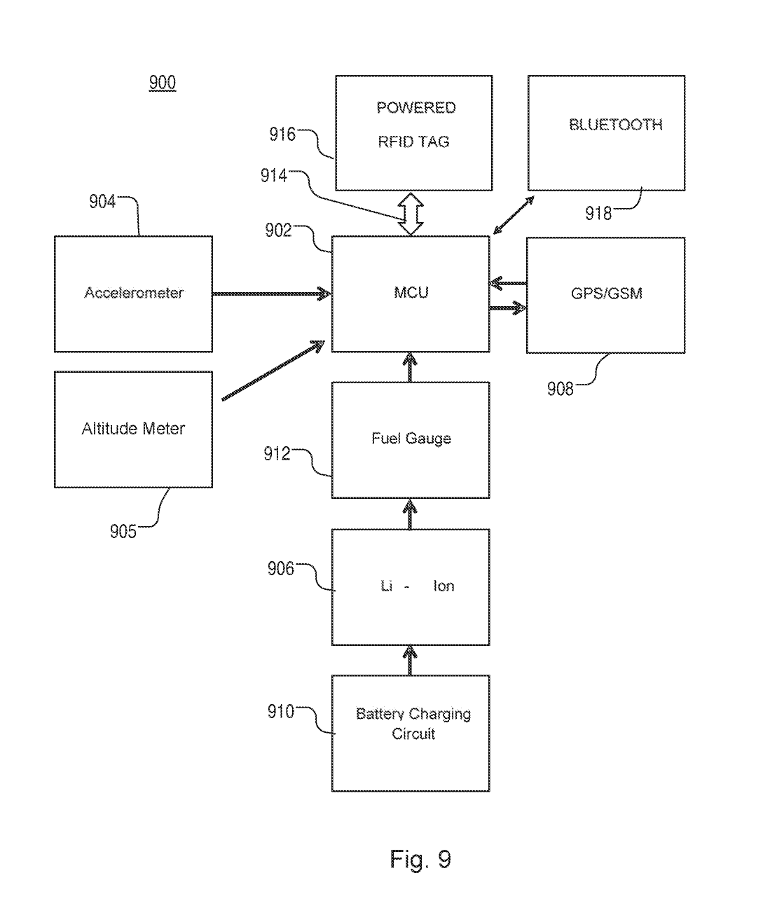

FIGS. 8 and 9 illustrate hardware components of a tag device 101 usable in the systems described above. It should be noted that the tag device is not purely based on RFID technology. Rather the RFID tag component within the device is combined in one unit with what is effectively a dumb mobile phone. This allows the tag device to be tracked and traced using GPS and GPSM cellular data networks as well as the features already embodied in RFID technology.

In the embodiment of FIG. 8, electronic circuitry for the dumb mobile phone is provided to work alongside a passive RFID card. In terms of physical housing, an RFID card can slide into the outer casing of the electronic circuit to provide a global track and trace product. This product (the tag device) is not just limited to airline baggage applications but can cover numerous applications—e.g. parcel tracking, livestock, warehouse inventory management, children, pets, cars, motorbikes, bicycles or any other item of value a tag device can be attached to.

At a functional level, the tag device can be used for a multitude of applications. The RFID function may be effective while baggage is in the possession of the airlines to allow airlines and airports to track and trace. The individual user then has the GPS and cellular data networks to help track and trace independent of airlines and airports.

In some embodiments, the RFID tag is configured to function in isolation from the dumb phone hardware. In other illustrated embodiments, the RFID tag does not function in isolation from the dumb phone hardware. Rather, an RFID reader is included in the hardware so that the hardware can read the passive RFID tag. The hardware may also be able to amplify/boost the range over which the tag can be read by other devices by energizing the passive RFID tag.

The hardware may also be capable of being alerted when the RFID is being read by another device. This can allow baggage for example to be tracked inside the airport via the user device and lighting up the hardware like a locator beacon each time it is read. In addition to the user device lighting up, in one embodiment, the smart tag could have an LED or other light source that activates and lights up physically. This is helpful when the baggage is on the conveyor belt and someone needs to identify the bag.

The tag device hardware can be programmed to decide to opt for the best technology available for the device to confirm position and/or track the tagged item. Bluetooth and near field communications protocols can be considered as additions to RFID, GSM and GPS communication functions. In addition, the device can be programmed to perform intelligent switching/combination of the best technology for determining location of the tag device, as between RFID, GPS, Cellular, Bluetooth, NFC and Wi-Fi etc. (As is known from cellular network positioning, other wireless devices can be used as references to determine relative position, as a supplement or alternative to global positioning by satellite.) An altitude meter can be provided and used to switch off certain technologies at certain altitude. This is useful as a safety/regulatory compliance feature when smart tag is used on baggage in aircraft where cellular and other wireless communication functions may be regard as safety hazards.

Power management for the device includes switching off the device or specific components within the device when not moving. It may be switched off when the user's application is switched off and only awakened on demand. This could also be triggered by altitude meter in one example. Battery charging may be via USB cable from smartphones or laptops/tablets. Charging may also be by induction charging, solar charging or power absorption from external RFID scanners or other devices.

FIG. 8 is a block diagram for the hardware section 800 of the tag device of the type disclosed. Arrows depict the main flow of information or, in the case of the charging circuit, flow of control. The hardware comprises a microcontroller (MCU) 802 operating under control of preloaded firmware. The device also holds an accelerometer 804 for movement analysis and a rechargeable Li-ion battery 806. Location and cellular communication functions are provided by GPS and GSM module 808. This may be based on a commercially available unit such as SIM908 module supplied by SimCom (available in the USA through Micron Electronics; www.simcom.us). This module handles all the communication over the GSM network and provides all the data back to the on board MCU. The module also handles all of the RF and communications to the GPS network, again, sending the required data back to the main MCU.

Accelerometer 804 allows the firmware on the main MCU to put the electronic system of the tag device into a low power state when the unit is not in transit, as there is no need to update the position. In this state, the GSM/GPS module can be put into a state where the RF section is turned off, minimising power consumption, but removing all possibilities of communication. The firmware can then start up the communication module once more if either movement has been detected through the accelerometer, or an internal timeout on the MCU has occurred. Also an altitude meter 805 is provided to enable the power and communication management functions, as already described above.

Rechargeable Li-ion battery 806 is managed via a charger circuit 810. This may be for example a chip from Microchip Technology, such as MCP73812T-420I/OT (www.microchip.com). A charging level indicator or “fuel gauge” circuit 812 is also provided. This may be for example a chip DS2782E+T&R from Maxim Integrated (www.maxim-ic.com). The charger handles everything around the recharge cycle when a USB is plugged into the board. The fuel gauge will inform the MCU of the charge and voltage of the battery.

An RFID tag interface 812 is provided, by which MCU 802 can read and optionally write information to the RFID tag 816 to implement the functionality of the tag device and tracking system as described throughout this disclosure. Also optionally, the interface 814 can detect when RFID tag 816 is interrogated by an external RFID reader, such as the scanners shown in FIG. 2 and described above.

The electronic system is controlled entirely by on board MCU 802 which may be for example of type PIC24FJ64GA002 from Microchip Technology. This processor takes information from the Accelerometer, the GPS/GSM module and the battery fuel gauge monitor and decides on an appropriate course of action based on these results. Optionally a Bluetooth interface 818, NFC interface etc. may be provided. If desired, indicator lights (not shown) can be provided, as described above.

FIG. 9 shows a modified hardware system 900. This is the same as the system 800, with like reference signs indicating like components. The main difference is that an active RFID tag 916 is included with a suitable power interface 914. As mentioned above, the range of the RFID signals may be increased by powering the tag. Power management can be provided by MCU 902 in the same way as for management of the power of the GPS/GSM communication module 808/908.

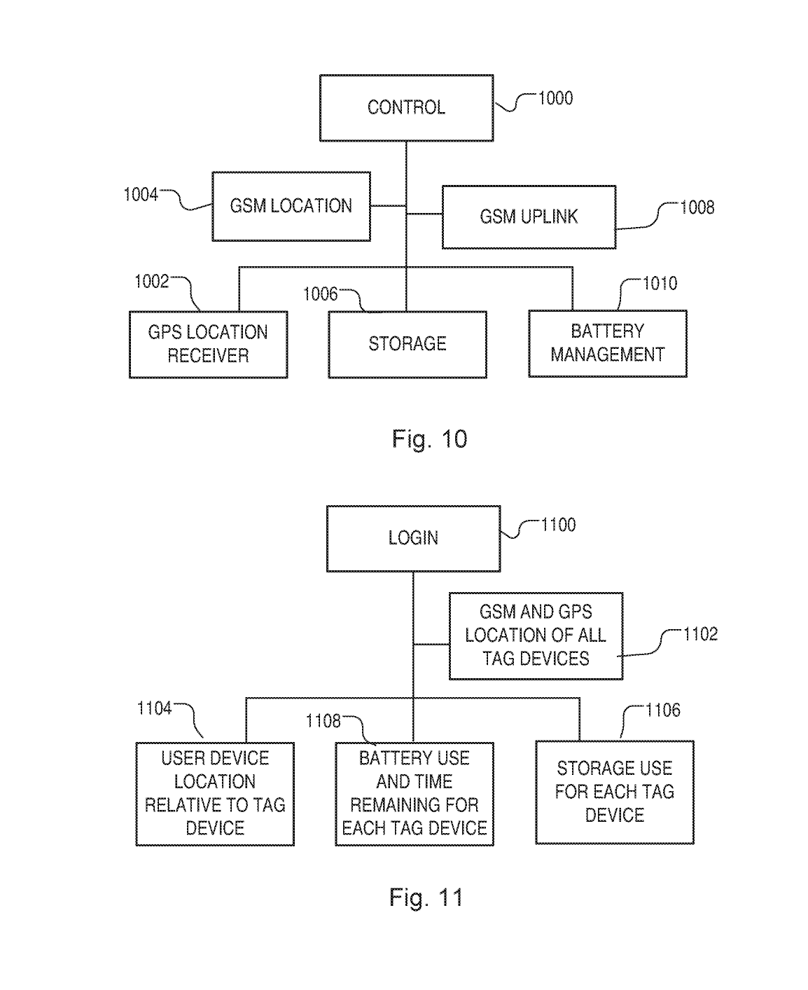

FIG. 10 shows schematically the structure of firmware controlling the hardware system 800 or 900 in a tag device of the type disclosed. The firmware comprises a number of program modules, of which the main ones are illustrated. A core control module 1000 administers the operation of the MCU and provides operating system functions for the other modules. A module 1002 is responsible for collecting GPS Information via the GPS chipset (module 808/908). This GPS information will be stored in MCU memory, managed by a storage module 1006. The stored GPS information is then used to try and create an accurate location. The GPS chipset will record the longitude and latitude of the board, and will send it to the storage module to be stored. The GPS location data can then accessed as required by other modules.

Similarly a module 1004 is provided to access GSM signal information from module 808/908 and implement a trilateration system to work out position via GSM, using the strength of signals from three or more cell towers in range, to work out the location of the board. This data will be collected and stored by storage module 1006. This

GSM location provides an alternative or additional source of location information, as well as GPS. Using both systems in conjunction with each other, the system can obtain a more accurate location of the device.

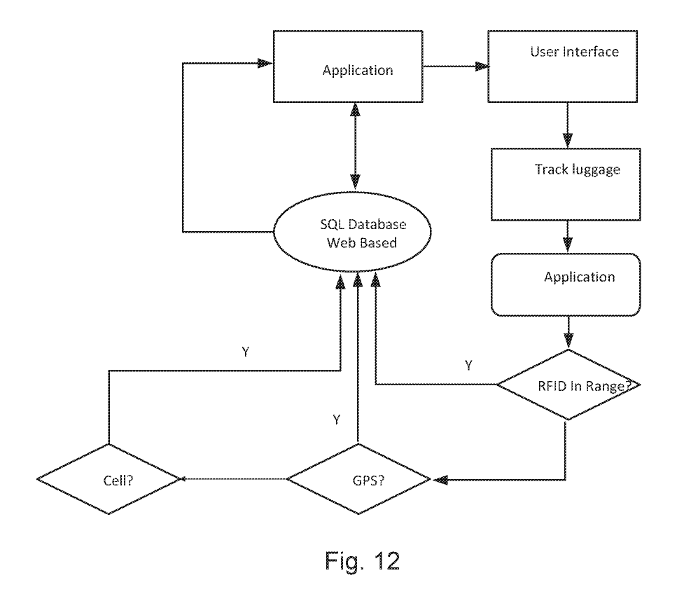

The flow diagram of FIG. 12 illustrates how location information can be sought in a hierarchy, trying first for RFID location, then trying for GPS signals, and finally using GSM location if those other methods are unsuccessful. This search method can be automated by programming in the MCU and/or automated by remote operation through the server application, the user device application and cellular communication.

The device will need to send this location information to the User Device (for example a phone), described already above. For this purpose, a GSM uplink module 1008 is provided to manage communication between MCU 802/902 and the cellular network. Rather than communicate information directly to a user device, it has been explained already above that all the tag devices will communicate via databases on a central server (214, FIG. 3). The device will upload information to a server database and the application on the user device (500) will access this information from the database. As an implementation of this access, the GSM module 1008 can send an encrypted email/SMS message via the cellular network to server 214, where it will be decoded and stored. If the user device sends the correct keys and IDs, the server will send them back the information collected from their board. Server software structure is described below with reference to FIG. 11.

Optionally, where the device hardware includes an NFC or Bluetooth interface (818/918), a user device with suitable pairing keys can quickly get data directly to and from the tag device hardware, without requiring a GSM signal or server communication.

### GPS Location

The storage module 1006 on the board will hold the latest information recorded from the GPS and GSM modules. It will also store the device IDs, keys and as many previous locations as possible. This information collected will help the system give more accurate and relative information based on the request from the user's device. For example if they wanted to find out the location of the device minutes into the past, the storage system can look through its information and communicate all previous data to the time requested. (Historical location information can also be stored in the server 214, if desired, and/or the user device application.)

Another important module in the firmware is battery management module 1010. This operates to ensure the tag device stays active for long periods of time. To this end, module 1010 does not have the battery-draining components on all of the time, only turning each component on when needed to, for example when it detects movement through accelerometer 804/904. Aside from accelerometer signals, the module 1010 can work out this movement by turning on the device, checking the location via module 1002 and/or 1004 and comparing with a previously stored location. If the device has not moved, it will turn off until further notice, or until a long timeout has passed. If the module 1002 or 1004 has recorded a movement, components of the device can remain active and record all locations. Even when active, components may be disabled with a periodic timeout.

FIG. 11 illustrates main functional modules of tagging application software for users. This may be implemented in the server 214 for example, or in a separate server, accessible via a standard web browser. Alternatively, the software may be implemented as user application 451 in user device 450 (FIG. 6). The software comprises various modules that interconnect with one another, as will now be described. The skilled person will recognize that any suitable operating system and programming language can be used to implement these modules, based on the functional description outlined here.

FIG. 12 shows general flow of handling of information and actions through the entire tagging system, including the server 214, user device 450, and the infrastructure scanners 201 etc. system. The software comprises various modules that interconnect with one another, as will now be described. The skilled person will recognize that any suitable operating system and programming language can be used to implement these modules, based on the functional description outlined here.

Module 1100 manages user login with the correct keys and IDs. The software will connect to the database, and for the user to be able to access the database to gather their tag device's information, the KEY and ID must be right. More than one device can be linked to a single ID. This will allow one login for the users to use to access all data for each of their devices. Once logged in the software will offer lots of features, including the current location of the board and its recent locations, the location of all boards linked to specific ID, the location difference between the user's device and the board, storage use, battery level and estimated time left on the battery. Optionally the software and hardware can provide different ways of logging in, for example logins for temporary users, and a NFC system to feed information directly off the board without requiring a server connection.

The main feature of the app is to show the exact location of the device. This function is provided by module 1102. In one embodiment it uses both locations of GSM and GPS to make one single point. When clicking more detail a user can access both individual GSM and GPS locations. Further features of the software may include a location prediction function which can estimate the direction the board will travel by looking at recent movements.

The location of the device (or each device if a user has more than one) will be shown on a digital map for example via a pin, and the map can be switched between different modes, for example hybrid or aerial image (satellite) views. As well as the location of the tag device, module 1104 uses the device's own location services to show the user's location on the map. The user can then see where the tag device(s) is(are) in comparison to the their own location. The user device can be configured to cause alerts, messages or other indicators to be generated on the user device, such as by lighting up the user interface of the user device, to indicate the location of the tag device being tracked. Where there is more than one tag device to be shown, different styles of pin or icon (clipart) can be used to represent each different device. This may be representing the different pieces of baggage. In the case where one of the tags is actually for tracking a pet, for example, an icon of a dog may be used.

storage status module 1106 will show the user the storage status of the or each tag device. This will allow the user to see how much data and how far into the past they can see. A user interface may be provided to show this storage status by clicking on a representation of the tag device in question, and then clicking a “storage” button. The user will be able to see the amount of storage left and how long the device can keep going for before having to start delete data.

A battery status module 1108 is provided. As conserving battery is one of the most important functions in managing the tag devices, making sure the user knows how long is left until the battery will run out is crucial. Module 1108 therefore shows the amount of battery left by clicking on a representation of the device in question and clicking a “battery” button. Once you click battery you will be able to see the percentage of battery left, as well as the estimated time left before the battery runs out.

As mentioned hereinbefore, FIG. 12 also illustrates the intelligent switching operation of the system. The tag system is programmed to perform intelligent switching/combination of the best technology for determining location of the tag device, as between RFID, GPS, Cellular, Bluetooth, NFC and Wi-Fi etc. In one embodiment, the system is programmed to switch between RFID, GPS, Cellular, Bluetooth, NFC and Wifi according to the most accurate positioning data, the most accurate positioning signals, and/or the strongest positioning signals (see FIG. 12 as one example of the sequence in the intelligent switching process in which the tag system is intelligently switching between RFID, GPS and cellular communication devices). In FIG. 12, the system first attempts to determine the tag device location using the RFID hardware (this could be via external RFID readers in the user end device and elsewhere). If RFID is not in range, the system then attempts to determine the tag device location using the GPS system. If the GPS system cannot determine the tag device location, the tag system then determines the tag location using the cellular communication system. In other embodiments, the system is programmed to perform intelligent switching between other combinations of the communication technologies (combinations of two or more of the aforesaid technologies are envisaged). Alternatively, in one embodiment, the system determines the tag location based on each communication technology and then presents each determined tag location to the user so that the user can consider the determined locations together. In yet another embodiment, the system determines locations using each communication technology and then compares all the determined locations to evaluate the tag device location. For example, the tag system can take an average of all the determined tag locations and present this to the user device interface or can pick a plurality of tag locations that are closest to one another in position.

While preferred embodiments of the present invention have been described and illustrated in detail, it is to be understood that many modifications can be made to the embodiments, and features can be interchanged between embodiments, without departing from the spirit of the invention.

1. A tag device comprising in a self-contained unit:
an RFID tag containing identifying information readable by an RFID reader device;
an electronic communication circuit by which the tag device can communicate with remote systems independently of an RFID reader device; and
a battery for powering said communication circuit.

2. A tag device as claimed in claim 1 wherein the electronic communication circuit includes a cellular communications module for communication via a cellular data network.

3. A tag device as claimed in claim 1 further including a location circuit, the tag device being operable remotely to report its location via the cellular communication network.

4. A tag device as claimed in claim 3 further operable to obtain and report a location based on trilateration using a cellular network.

5. A tag device as claimed in claim 1 further including an RFID reader interface for transferring information from the RFID tag to the electronic communication circuit.

6. A tag device as claimed in claim 1 further including an RFID write interface for transferring information to the RFID tag from the electronic communication circuit.

7. A tag device as claimed in claim 1 further including an RFID tag power interface for at least intermittently powering the RFID tag from the battery.

8. A tag device as claimed in claim 1 further including a power management function circuitry for automatically disabling components of the tag device to maximize battery life.

9. A tag device as claimed in claim 8, wherein the power management function includes one or more of an accelerometer and an altitude meter.

10. A tag device as claimed in claim 9, wherein the power management function circuitry is configured to operate by comparing sensed locations over time.

11. A tag device as claimed in claim 1, wherein the electronic communication circuitry further includes at least one of a satellite GPS device, a Bluetooth communication device, a near field communication device and a WiFi communication device.

12. A computer-implemented method for monitoring and retrieving baggage items, the method comprising:
receiving user information in a computer processing system;
based on said received user information, programming, by said computer processing system, at least one RFID tag for tagging at least one baggage item;
receiving, by said computer processing system, a user interface entered selection of at least one identifier of the at least one RFID tag associated with the at least one baggage item;
electronically tracking said selected at least one RFID tag;
determining, by said computer processing system, the geographic location of said selected at least one RFID tag and/or status information about said RFID tag according to said electronic tracking; and
presenting on the user interface the geographic location and/or the status information on the user interface for monitoring said at least one tagged baggage item.

13. The method of claim 12, wherein programming, by said computer processing system, at least one RFID tag based on said user information comprises programming a plurality of RFID tags for tagging a plurality of baggage items; and
wherein receiving, by said computer processing system, a user interface entered selection of the at least one RFID tag identifier comprises receiving, by said computer processing system, a user interface entered selection of the at least one RFID tag identifier selected from among RFID identifiers of the plurality of said RFID tags.

14. The method of claim 13 wherein electronically tracking the at least one RFID tag comprises electronically tracking concurrently said selected plurality of RFID tags.

15. The method of claim 12, wherein at least one of said RFID tags is combined in a self-contained tag device with an electronic communication circuit by which the tag device can communicate with remote systems independently of an RFID reader device and a battery for powering said communication circuit, and wherein electronically tracking the at least one RFID tag includes communicating remotely with the electronic communication circuit.

16. The method of claim 15 wherein said RFID tag is further combined in said self contained unit with a location circuit, wherein electronically tracking the RFID tag comprises causing the tag device to report its location via the communication circuit using information generated by the location circuit.

17. An apparatus for monitoring and retrieving baggage items, the apparatus comprising: a memory storing instructions; and
one or more processors, wherein said instructions, when processed by the one or more processors, cause:
receiving user information in the apparatus;
based on said received user information, programming, by said computer processing system, at least one RFID tag for tagging at least one baggage item;
receiving, by said computer processing system, a user interface entered selection of at least one identifier of the at least one RFID tag associated with the at least one tagged baggage item;
electronically tracking said selected at least one RFID tag;
determining, by said computer processing system, the geographic location of said selected at least one RFID tag and/or status information about said RFID tag according to said electronic tracking; and
presenting on the user interface the geographic location and/or the status information on the user interface for monitoring said at least one tagged baggage item.

18. The apparatus of claim 17, wherein said instructions, when processed by the one or more processors, further cause:
intelligent switching between at least two of RFID, GPS, Cellular, NFC, Bluetooth and Wifi technologies to determine the location of the tag device.

19. The apparatus of claim 17 adapted for use with an RFID tag that is combined in a self-contained tag device with an electronic communication circuit by which the tag device can communicate with remote systems independently of an RFID reader device, and wherein electronically tracking the at least one RFID tag includes communicating remotely with the tag device via the electronic communication circuit.

20. The apparatus of claim 19 wherein said self-contained unit further includes a location circuit, wherein electronically tracking the RFID tag comprises causing the tag device to report its location via the communication circuit using information generated by the location circuit.

21. (canceled)

22. (canceled)
